(19) United States
(12) Patent Application Publication
(10) Pub. No.: US 2011/0225614 A1
(43) Pub. Date: Sep. 15, 2011

(54) MULTI-POINT DIGITAL VIDEO RECORDER FOR INTERNET-DELIVERED TELEVISION PROGRAMMING

(76) Inventors: R. Michael Peters West, Colchester, VT (US); Robert Francis Shambro, Las Vegas, NV (US)

(21) Appl. No.: 13/044,889

(22) Filed: Mar. 10, 2011

Related U.S. Application Data
(60) Provisional application No. 61/312,473, filed on Mar. 10, 2010.
(60) Provisional application No. 61/312,409, filed on Mar. 10, 2010.
(60) Provisional application No. 61/312,431, filed on Mar. 10, 2010.

(51) Int. Cl. H04N 7/173; H04N 7/20

(52) U.S. Cl. 725/63; 725/109

(57) ABSTRACT

Methods, systems, and apparatus for sharing a content viewing experience among geographically separated participants. An invitation to view a common audio-video content item may be distributed to a plurality of individual clients of geographically separated participants in the content viewing experience. The invitation may include, for example, a description of the common audio-video content item, a time the common audio-video content item is available for distribution, means for accepting the invitation, and/or a comment. When an acceptance of the invitation is received, the common audio-video content item may be distributed to the individual clients of participants that accepted the invitation during the time the common audio-video content item is available for viewing. The individual clients of participants that accepted the invitation may then play the common audio-video content item under the common control of one of the clients.

### RELATED APPLICATION

This application is a NONPROVISIONAL of, claims priority to, and incorporates by reference U.S. Provisional Patent Applications 61/312,473 filed 10 Mar. 2010, 61/312,409 filed 10 Mar. 2010, and 61/312,431 filed 10 Mar. 2010.

### FIELD OF THE INVENTION

The present invention relates to methods and systems for sharing a content viewing experience among geographically separated users in a network-based content delivery system.

### BACKGROUND

Today, watching television (or content from a digital video disc (DVD), personal video player, or other source) is a “single-point” experience that can be shared only with a group of viewers gathered around the same television set (or other viewing platform). That is, although people in different households (or different rooms of the same house for that matter) may be able to watch the same television program on their individual television sets, the experience remains a solitary or isolated one for those viewers (or groups of viewers) because each watches the program on his/her/their own terms, without interacting with the other viewers (or groups of viewers) at geographically dispersed locations.

### SUMMARY

Methods, systems, and apparatus for sharing a content viewing experience among geographically separated participants are herein disclosed. An invitation to view a common audio-video content item may be distributed by one (or more) client to a plurality of individual clients of geographically separated participants in the content viewing experience. The invitation may include, for example, a description of the common audio-video content item, a time the common audio-video content item is available for distribution, means for accepting the invitation, and/or a comment. The network-based content delivery system may be, for example, a television content distribution network, a hybrid fiber coaxial cable content distribution network, a satellite content distribution network, a local area network (LAN) content distribution network, a wireless LAN (WLAN) content distribution network, and/or an Internet based content distribution network.

When an acceptance of the invitation is received, the common audio-video content item may be distributed to the individual clients of participants that accepted the invitation in advance of, or at the agreed upon viewing time as indicated in the invitation. The common audio-video content item may only be viewed during the time the common audio-video content item is legitimately available for viewing, although distribution may occur prior to that time provided viewing is prevented outside the time of legitimate viewing.

The individual clients of participants that accepted the invitation may then play the common audio-video content item under the common control of one of the clients, often but not necessarily the client that generated the invitation. In one embodiment, common control of the common audio-video content item may be transferred to a different client or multiple clients. In some instances, an option to opt out of viewing the common audio-video content item may also be provided.

In one embodiment, a reminder notice may be distributed to one or more of the individual clients of participants that accepted, or have yet to accept, the invitation. The reminder notice may include, for example, a start time for the viewing of the common audio-video content item and/or an indication that the common audio-video content item is available for viewing.

In another embodiment, a request to reschedule distribution of the common audio-video content item may be received from one or more of the clients. When the request to reschedule distribution of the common audio-video content item is accepted, a new invitation to view the common audio-video content item may be distributed to the plurality of participants. The new invitation may include, for example, a new time that the common audio-video content item is available for distribution and/or a new time for viewing the common audio-video content item.

In a further embodiment, an opportunity for in-band interaction among participants may be provided via, for example, each participant's respective client. Examples of in-band interaction include a posting of a message by one or more of the clients, an exchange of in-system messages between clients, a threaded discussion board, a text message, an audio feed, and a video feed. On some occasions, the in-band interaction is displayed along with the common content item. In one instance, the in-band interaction may be synchronized with the viewing experience and may occur in real time relative to the viewing experience.

In some embodiments, a plurality of display options for viewing the common audio-video content item may be provided to the clients. Selection of a display option for viewing the common audio-video content item may be controlled by, for example, the client controlling the playing of the common audio-video content item and/or the individual participants that accepted the invitation.

In a further embodiment, a playlist of common audio-video content items may be generated. An invitation to view the playlist may be distributed to the plurality of geographically separated participants. The invitation may include a description of, for example, the playlist and/or one or more of the common audio-video content items included in the playlist.

In a still further embodiment, contact information for a participant may be received and a community of participants may be generated using the received contact information. On some occasions, the contact information may be received via uploading a contact list from a source external to the server.

In one embodiment, the invitation may be distributed at the request of a particular client that is associated with a client account with, for example, the network-based content delivery system. The client account may be updated to indicate, for example, the distribution of the invitation, the acceptance of the invitation, receipt of a rescheduling request, an indication of the client in common control of the playing of the common audio-video content item, and/or a playing of the common audio-video content item by a participant. In another embodiment, one or more of the participants may be associated with participant accounts with the network-based content delivery system. These participant accounts may be updated to indicate, for example, receipt of the invitation, acceptance of the invitation, and/or a schedule of common audio-video content items available for playing.

In one embodiment, a determination of whether a participant has sufficient subscription rights to view the common audio-video content items may be made. If the participant does not have sufficient subscription rights, an opportunity for the participant to purchase subscription rights sufficient to view the common audio-video content item may be provided to the participant. Otherwise, playback of the common audio-video content items may be facilitated on the second client.

In a further embodiment, the invitation may be sent to a wireless communication device other than an individual client of a participant and, in some cases, the acceptance of the invitation may be received from the wireless communication device. Examples of wireless communication devices include a mobile phone, a personal digital assistant (PDA), and a laptop computer.

Exemplary systems for sharing a content viewing experience among geographically separated participants in a network-based content delivery system include a server and one or more individual clients communicatively coupled to one another. The server may be configured to, for example, distribute an invitation to view a common audio-video content item to individual clients of a plurality of geographically separated participants in the content viewing experience. The invitation may include, for example, a description of the common audio-video content item, a time the common audio-video content item is available for distribution, and/or means for accepting the invitation. The server may be further configured to receive an acceptance of the invitation, and distribute, during the time the common audio-video content item is available for viewing, the common audio-video content item to each of said individual clients of participants that accepted the invitation.

The individual clients may be configured to, for example, receive the invitation from the server, accept the invitation, receive the common audio-video content item from the server, and/or play the common audio-video content item.

Exemplary apparatus for sharing a content viewing experience among geographically separated participants in a network-based content delivery system may include means for distributing an invitation to view a common audio-video content item to individual clients of a plurality of geographically separated participants in the content viewing experience. The invitation may include, for example, a description of the common audio-video content item, a time the common audio-video content item is available for distribution, and/or means for accepting the invitation.

Upon receipt of an acceptance of the invitation the apparatus may be further configured to distribute, during the time the common audio-video content item is available for viewing, the common audio-video content item to each of said individual clients of participants that accepted the invitation.

### BRIEF DESCRIPTION OF THE DRAWINGS

The present invention is illustrated by way of example, and not limitation, in the figures of the accompanying drawings, in which:

FIG. 1 illustrates an example of a network configured in accordance with an embodiment of the invention for delivering television content over the Internet;

FIG. 2 illustrates an example of a set-top box configured for use in a network such as that depicted in FIG. 1;

FIG. 3 illustrates an example of a process for inviting participants to a shared viewing experience in accordance with embodiments of the present invention; and

FIGS. 4A-4C illustrate examples of viewing modes for a shared viewing experience in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

Described herein are methods and systems for sharing a content viewing experience among geographically separated users in a network-based content delivery system. The content may be television programming delivered via the Internet or other computer-based networks or via conventional cable (i.e., hybrid fiber coax) or satellite television networks. In one embodiment, the invention provides a digital video recorder (DVR)-like experience for multiple geographically separated users, in that the users all view the same content at the same time, through their own televisions or other content viewing platforms, and one user is provided the ability to control the playback of the content with trick mode style controls (e.g., play, fast-forward, rewind, pause, stop, etc.). Optionally, the users (or a subset thereof) may share text or other comments with one another and such comments may be presented on-screen (overlaid on or adjacent to the content being viewed). Further, in some embodiments, the users may share audio/video feeds (e.g., provided via web cams or the like) with one another (or a subset thereof). In either instance, the effect is one of sharing a viewing experience with others as if they were co-located with one another instead of being geographically dispersed. These and further embodiments of the invention are described below and those of ordinary skill in the art will recognize that the present invention finds applicability to content and/or services delivered to users by a conventional cable or satellite network as well as via the Internet or other computer-based network.

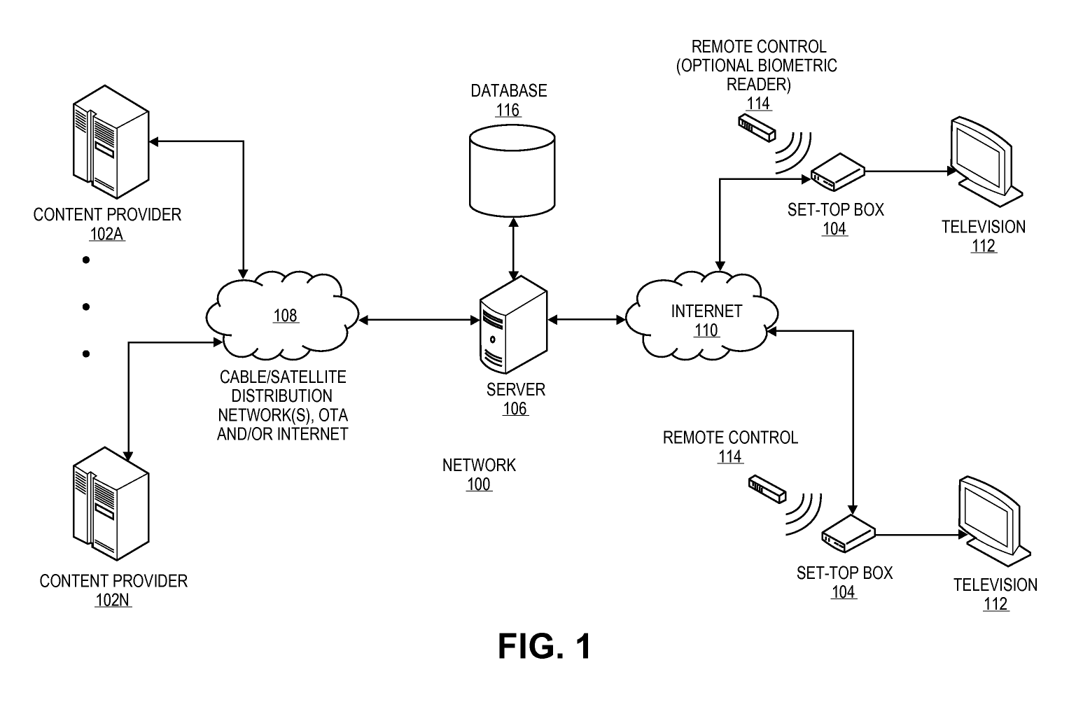

Referring first to FIG. 1, an example of a network, 100 configured for delivery of television content via the Internet or other computer-based network in accordance with embodiments of the invention is shown. As indicated above, however, the present invention is equally applicable to other television content delivery means, including cable and/or satellite distribution means, and so the following description is intended only as an example of the environment within which the methods and systems that comprise the invention may be implemented. The television content is delivered from various service providers 102A-102N, preferably on a user-defined, à la carte basis, to one or more subscribers, each equipped with a set-top box 104. That is, subscribers to an Internet-delivered television service are each able select their own service offerings, i.e., each subscriber may select his/her own set of television channels instead of having to select prepackaged channel/content offerings designed by a cable, satellite or other service provider. In this way, the subscribers may choose any number of television channels, in any combination, and pay subscription fees solely according to their selections.

This à la carte service offering is made possible by collecting or channeling the television content from the many service providers 102A-102N at/through a server 106 (note, although only one server 106 is illustrated, it should be appreciated that this one server may represent many servers, arranged in central or distributed fashion, in order to accommodate a large subscriber base—for example, such servers may be organized as a central cloud and/or may be distributed geographically or logically to edges of a network in order to minimize service latencies; in either instance, various content may be replicated across the servers that make up the distribution network). Server 106 may receive the content via any of a number of means 108, including conventional cable or satellite television distribution means, over-the-air broadcast, or via one or more computer-based networks, such as the Internet. The content is delivered from server 106 to the various set-top boxes 104 via the Internet 110. Server 106 stores this content (either itself or in attached storage) and may distribute the content for retention on/by other servers within the network. The content is retained for a period of time (which may vary depending on the content, the content providers' wishes, the available storage space, the popularity of the content, etc.) allowing such stored content to be accessed by subscribers at a later time. In this way, the network may operate as an on-line digital video recorder. The television content includes television programming (e.g., both stored and live programming), Internet-based content (including subscriber-generated content), and metadata that includes information about the programming and other content (including, but not limited to, episode names, dates and times of broadcast, etc.).

Each set-top box is communicatively coupled to server 106 (e.g., via a local area network (LAN) using either a wired or wireless connection to a modem or similar equipment that couples the LAN to the Internet in order to exchange data therewith, and, in turn, delivers the content to an associated television or monitor 112 that is communicatively connected to the set-top box (e.g., via a wired or a wireless connection). Individual channel selection may be made via a wireless remote control 114 that is communicatively coupled to a respective set-top box. Selection may be via the electronic program guides discussed below, and/or via hard buttons or other user-manipulable selectors (rocker switches, touch screens, etc.) present on the remote control. The remote control may optionally be fitted with a biometric reader, such as a fingerprint reader, for use in identifying the user holding or operating the remote control. The use of biometric readings facilitated by such devices allows for the generation and presentation of customized electronic program guides for the user. Of course, user identity may be established in other ways, for example using a log-in process and/or using other biometric readings taken by sensors associated with the remote control and/or the set-top box (or even a separate computer system or appliance communicatively coupled to the set-top box).

Server 106 is also communicatively coupled to a database or other storage means 116. This database may be used to store subscriber information, such as subscriber profiles, subscriber channel selections, subscriber-customized electronic program guide preferences, copies of television content (for on-demand viewing, etc.), and other information. As noted above, server 106 (in some cases, together with other servers and associated data storage devices) retains content for a period of time, allowing it to be accessed by subscribers in an on-demand or time-shifted fashion. The subscriber channel selection information may include information regarding current channels subscribed to by a subscriber, gifted channels provided to others by a subscriber, one-time channel subscriptions for on-demand viewing, etc.

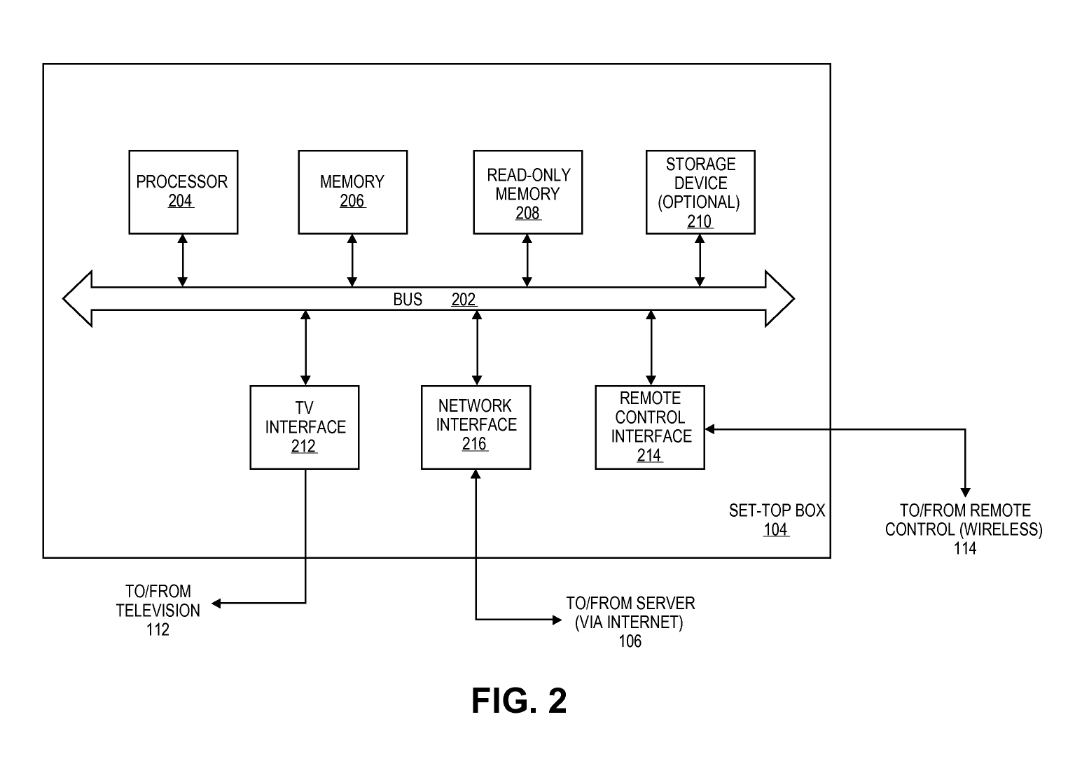

FIG. 2 illustrates features of a set-top box 104 in greater detail. Note that the example in FIG. 2 is intended only as one possible set-top box configuration and is not intended to limit the scope of the present invention in any way. Many of the features and functions provided by the elements described below could be integrated on a single system-on-a-chip or could be distributed over more or fewer modules that are discussed herein. Therefore, the precise hardware configuration of the set-top box is not critical to the present invention. It should also be noted that the use of set-top box 104 devices in the network 100 in FIG. 1 is merely illustrative, in that it would be recognized by those familiar with, and/or skilled in, the art that the functions provided by a set-top box 104 could be integrated within, or distributed across, other or different components of the network 100. For example, modern consumer electronics devices such as televisions, optical disc players, DVRs, home theater systems and the like are available with “Internet Enabled” or “Internet Ready” capabilities. Such devices would integrate some or all of the functionality of a set-top box 104 and therefore potentially eliminate the need for such a set-top box 104.

In the illustrated example, set-top box 104 includes a bus 202 or other communication mechanism for communicating information, and a processor 204 coupled with the bus 202 for processing information. The set-top box also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204. Set-top box 104 further includes a read only memory (ROM) 208 or other static storage device coupled to the bus 202 for storing static information and instructions for the processor 204. An optional storage device 210, such as a magnetic disk or flash memory, may be provided and coupled to the bus 202 for storing (at least temporarily) television and/or electronic program guide (EPG) content and instructions (e.g., the operating system for the set-top box, user EPG preferences, etc.). If present, storage device 210 (which may, in some instances, be an external storage device or a combination of an internal and an external storage device) may facilitate the use of the set-top box as a digital video recorder (DVR).

According to one embodiment of the invention, the processor (or other application specific hardware) 204 executes sequences of instructions contained in main memory 206 in order to decode (or encode) the audio/video content for presentation via television 112 and produce the customized on-screen EPGs which may be overlaid or otherwise presented via the television 112. Such instructions may be read into main memory 206 from another computer-readable medium, such as storage device 210 or ROM 208. In alternative embodiments, hard-wired circuitry may be used in place of or in combination with computer software instructions to implement the invention. Thus, embodiments of the invention are not limited to any specific combination of hardware circuitry and software.

Set-top box 104 may be coupled to television 112 via a television interface 212. Television interface may correspond to any of a number of conventional interfaces such as a high definition multimedia interface (HDMI) or other interface. An input device, such as the remote control 114, is communicatively coupled to the bus 202 for communicating information and command selections to the processor 204 via a remote control interface 214. Such an interface may be an infra-red (IR) or other interface. The input device should be configured to permit manipulation of an on-screen cursor along at least two axes, e.g., a first axis (e.g., x) and a second axis (e.g., y), allowing the device to specify positions in a two-dimensional plane.

Set-top box 104 also includes a network interface 216 coupled to the bus 202. Network interface 216 provides a two-way data communication path with server 106. For example, network interface 216 may be a wired or wireless local area network (LAN) interface to provide a data communication connection to a compatible LAN (such as a LAN that uses an IEEE 802.11a/b/g/n communication protocol). Set-top box 104 can send messages and receive data, including television content and EPG information, firmware updates, and other information through network interface 216.

Today, watching television (or content from a digital video disc (DVD), personal video player, or other source) is a “single-point” experience that can be shared only with a group of viewers gathered around the same television set (or other viewing platform). That is, although people in different households (or different rooms of the same house for that matter) may be able to watch the same television program on their individual television sets, the experience remains a solitary or isolated one for those viewers (or groups of viewers) because each watches the program on his/her/their own terms, without interacting with the other viewers (or groups of viewers) at geographically dispersed locations. The present invention overcomes this limitation and allows multiple viewers (or groups of viewers) to share the same viewing experience even if they are located remotely from one another.

As illustrated in FIG. 1, each set-top box-television combination can be regarded as a client of server 106 (in some instances it may be possible to couple multiple televisions or viewing platforms to a single set-top box, but for sake of simplicity and so as not to obscure the present invention, it will be assumed for purposes of the discussion herein that only one such television/viewing platform is connected to each set-top box). As such, and in accordance with the present invention, content may be provided from server 106 to multiple ones of these clients, simultaneously (or nearly so). Playback commands (e.g., play, fast-forward, rewind, pause, stop, etc.) from one client (which may for purposes of a shared viewing experience be considered a “leader” or “organizer”) can be used to control the provision of content to all clients of a designated group because the commands are directed at the playback originating from server 106. Thus, for a group of designated and remotely located clients, a shared viewing experience can be provided under the control of a single leader. The viewing experience may include trick modes and other playback options, to potentially modify the flow of the viewing experience, under the control of the leader or event organizer. In some circumstances, a plurality (from one up to the total number of clients) of leaders might be able to provide such control. Whether such “multi-leader” operation would be desirable, or confusingly annoying, could be left up to the participants. But for sake of simplicity and so as not to obscure the present invention, it will be assumed for purposes of the discussion herein that only one such leader, at any given time, is able to control the shared viewing experience.

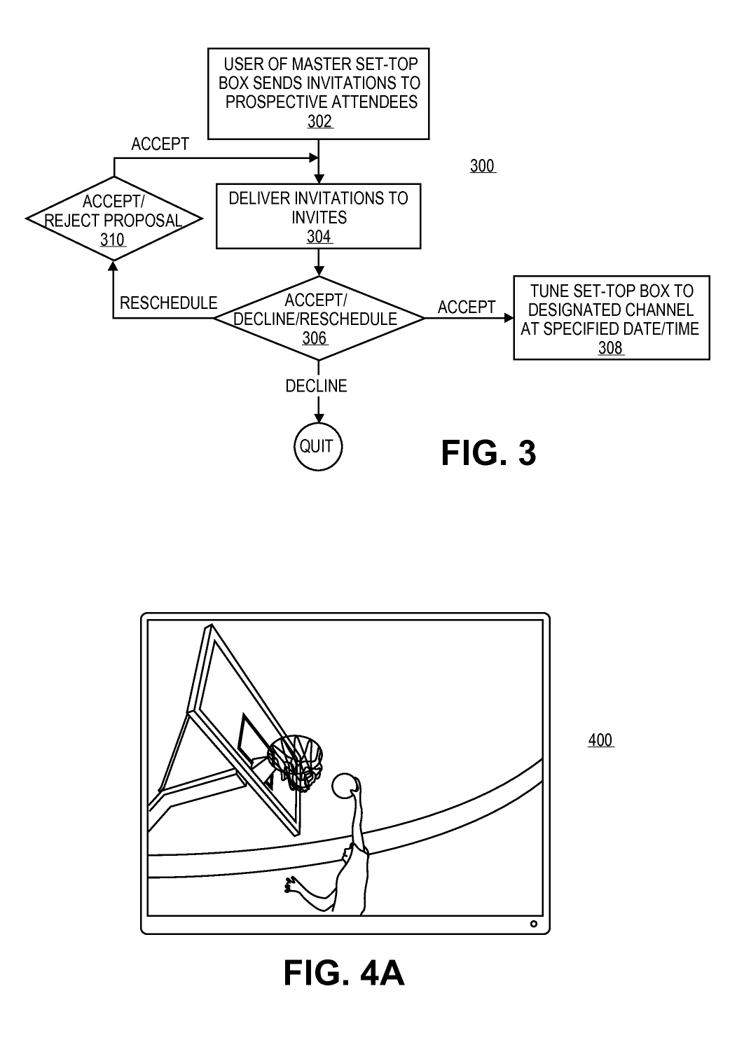

Designating the group of participating clients and the group leader may be accomplished in any of a variety of ways. For example, as shown in process 300 illustrated in FIG. 3, a group of clients for a shared viewing experience could be established with the leader sending invitations to prospective attendees (e.g., friends) 302. In some cases, the shared viewing experience may be a playlist of one or more content items selected by, for example, a group leader or an organizer of an shared viewing experience. The invitations may be distributed in-system via server 106 and through the set-top boxes of the invited participants and may be delivered 304 to the recipient immediately, via an on-screen notification through the recipient's set-top box, or may simply be indicated in an electronic mailbox accessible by the recipient. In the latter case, the recipient may be notified of the availability of a new message in his/her mailbox. The electronic mailbox may exist on the server 106 or the recipient's set-top box 104, or both.

Designating the group of participating clients may also be accomplished by the leader selecting contact information for prospective attendees from, for example, a contact list. In some cases, the contact list may be uploaded to server 106 via downloading a contact list from an external device associated with the leader such as a mobile telephone, a laptop computer, and/or personal digital assistant (PDA) to server 106. In other cases, the contact list may be stored at sever 106. On some occasions, the participating clients may be organized into a community using, for example, the contact information of the respective participating clients or an interest associated with the respective participating clients.

The messages may read as an invitation and specify a date, time and program for the shared viewing experience. Invited participants could accept or decline the invitation 306. For those that decline, the process ends. For those that accept, their set-top boxes would tune to the designated channel on which the program is being presented at the specified date and time 308. Alternatively, instead of automatically tuning to the designated channel, a reminder notice could be presented to an invitee, either on-screen or out of band (e.g., by way of email, instant message, automated phone call, etc.). Further, the reminder notice could be presented on-screen in advance of the scheduled time and the invitee given an opportunity to opt out of the viewing (even though the invitee had previously accepted) within a specified time, otherwise the set-top box will automatically tune to the scheduled channel.

In some embodiments, options could be provided for an invitee to propose scheduling changes if the invitee wants to participate in the event but cannot attend at the proposed date and time. The reschedule proposal would be sent to the leader, who could accept or reject the proposal 310. If the proposal is rejected, the process ends for the subject invitee, but if it is accepted, rescheduling notices are sent to the other invitees. In some cases, invitations may be sent to any users of the present system and not just friends of a user, for example in the case of a promotion where a celebrity, sponsor, promoter, service provider, or other individual (or group of individuals) will “host” a shared viewing experience.

In some instances, it may be the case that an invitee to a shared viewing experience is not a subscriber to the content or channel with which the shared viewing experience is concerned. In such eases, the organizer of the event (i.e., the user that initiates the invitations and will have, at least initially, control over the playing of the content) may be notified at the time the invitations are being created (or sometime thereafter, but prior to the event start date and time) and given the opportunity to purchase viewing rights for that invitee. This may come in the form of a one-time or other pass for the invitee or a complete channel subscription for the invitee. Or, the viewing fee may be charged to the organizer (e.g., to a special account maintained by the organizer for such circumstances or to the organizer's monthly or other periodic bill, etc.). In other cases, when an invitee that does not already have sufficient rights to view the content that is the subject of a shared viewing experience invitation receives the invitation, that invitee may be provided the opportunity to purchase such rights, either through a one-time or other pass or some other form of subscription. The organizer may be notified when the invitee has completed the purchase so that the organizer is aware that the invitee will be able to participate in the event.

As mentioned above, the organizer of the event will be the user that has initial control over the playing of the content during the shared viewing experience. Thus, any playback or other commands delivered by the organizer through his/her set-top will be instantiated not only for the playing of the content through the organizer's, set-top box, but also for the content as played through the other participants' set-top boxes. At times during the shared viewing experience, the organizer may cede control of the playing of the content to one of the other participants. This may be accomplished, for example, by executing a “transfer control” or similar command at the organizer's client in conjunction with designating a transferee leader to which control is being ceded. It may also be necessary for the transferee leader to accept control, though this is not necessarily so. In any event, when control is transferred (and, if needed, accepted), the transferee leader will then have the opportunity to control the playing of the content over all of the involved clients. Control may revert to the original leader either by having the transferee leader cede control or by the original leader regaining control without the consent of the transferee leader. Other implementations may involve a different, but functionally equivalent, set of commands.

The exchange of control over the playing of the content as described above is made possible because the server 106 (or a cluster of servers, which may be geographically distributed) is the source of the content (and, hence, may be regarded as a “DVR in the cloud”). Thus, the server can maintain a record of which set-top box has control of the shared viewing experience at any particular time. Further, participants in the experience can request control from the organizer (or transferee leader) by sending an in-band message or other alert requesting same. Control may be transferred accordingly (or not) simply by the organizer (or transferee leader) responding to the request. In other instances, control may rotate on a periodic, random, pseudo-random or other basis among the participants. Alternatively, participants may need to engage in games of chance or skill in order to “win: control from the organizer or the participant having control. When the shared viewing experience is a playlist, control of the viewing experience may remain with the participant, instead of the organizer.

In the case where “live” content is involved (e.g., a live sporting event, concert, news conference, etc.), content providers may place restrictions on shared viewing events. For example, content providers may wish to enforce blackout restrictions, time shifted playback schedules for viewers in different time zones, or other restrictions, that would limit the ability of invitees in different time zones and/or cities/regions to participate in a shared viewing experience. Generally, such restrictions may be identified in metadata or other information associated with the content and would be enforced by server 106 (perhaps unless the organizer or invitee(s) are willing to purchase special viewing rights). The organizer of an event may be informed of such restrictions (e.g., either generally or on an invitee-by-invitee basis) at the time the invitations to the event are being created (or thereafter if the restrictions are not known at the time the invitations are created) and/or each invitee may be so informed. Alternatively, the server 106 may simply block invitations to prospective invitees that would not be eligible to participate in a shared viewing experience as a result of such restrictions. Other examples of restrictions enforced in connection with a shared viewing experience may include prohibitions on trick mode operation (e.g., to preserve the dramatic intent of the content creator, etc.) or time-zone shifted playback of a first airing of a content item.

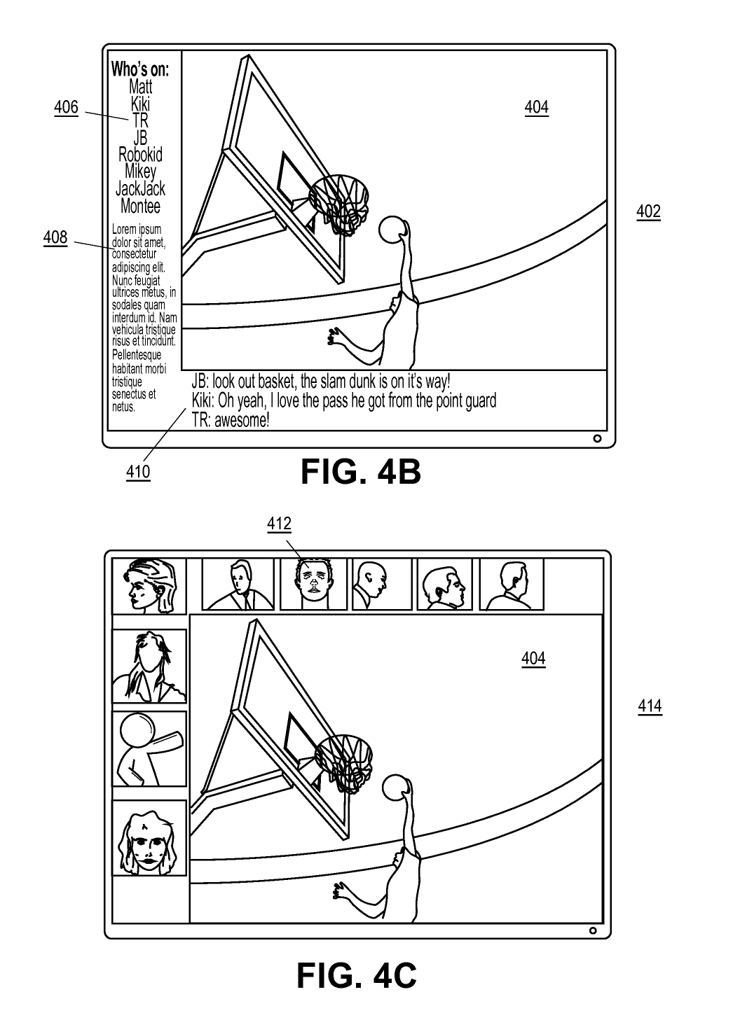

In addition to providing an opportunity for common control over a viewing experience for geographically dispersed viewers, the present invention provides an opportunity for in-band interaction among those viewers. For example, through an exchange of in-system messages, which may be presented as individual messages or as a threaded discussion board or as a bulletin board, etc., some or all of the participants in a shared viewing experience may communicate with one another in real time, in the context of the viewing experience. To better understand this statement, refer to FIGS. 4A-4C. In FIG. 4A, 400 designates the full screen viewing experience for any of the participants in the event. In this mode, the set-top box renders a full screen presentation of the content which is the subject of the event to a viewer's television or other viewing platform. This may be regarded as the normal viewing mode. However, this normal viewing mode could be enhanced by live audio feeds from some or all of the participants—allowing participants to exchange audible commentary or conversation while viewing the content in normal viewing mode.

In FIG. 4B, the viewing mode has changed to a discussion view 402. In this view, the content is displayed in a less than full screen area 404. This may be any portion of the full screen, but preferably retains the same perspective (e.g., 4:3, 16:9, etc.) as the full screen mode. Framing the content viewing area 404 are one or more of the following: a list of the participants in the shared viewing experience 406, a running discussion board where text comments of the participants are displayed (scrolling from top to bottom as new comments are received) 408, a comment composition area where a user can compose a message before posting it to the discussion board) 410. The positioning of such text message/comment areas on the screen is, of course, arbitrary and other arrangements than those depicted herein may be used (e.g., according to user and/or service provider preference) In FIG. 4C, a live web cam area 412 is provided (where web cam feeds from one or more of the participants can be presented). The web cam area 412 is shown in the context of a live discussion mode 414, where all participants are providing web cam feeds to one another and can engage in live audio-video conversations.

In addition to group discussion boards and/or group web cam feeds, private discussion boards/feeds may be established between subsets of the participants in the shared viewing event, much like such features can be provided between participants in an on-line presentation. This way, subgroups of participants can exchange private messages/web cam feeds with one another and not have their comments, etc., read and/or viewed by the entire group participating the event. This is especially useful for situations more akin to a “broadcast” where members of the public are invited to attend a “screening” hosted by a celebrity or sponsor, and a user wishes to limit his/her active interaction to just friends and not a host of unknown other participants. In some cases, the ability to use private communication boards or channels may be at the discretion and under the control of the leader. Where permitted, private channels may be established by selecting the recipients of a message from a participant list or through other means.

The ability to share text and/or audio-video comments with other, geographically dispersed viewers during a shared viewing event emphasizes the nature of the shared experience. Unlike situations where people in different households watch the same television program and then talk about it the next day, the present invention facilitates real time, in-band discussion among the viewers. Watching television goes from being a solitary, single-point event to a participatory, multi-point event.

Each participant's messages and/or web cam (or other audio-video feeds) are provided from each participant's set-top box, through server 106 (or a server farm, etc.) to the other participants' respective set-top boxes. The messages may be passed in the form of instant messages, emails, or other communication means. In some cases, the server may employ filtering software to screen out inappropriate comments. For example, vulgar language or other material may be redacted from messages or the messages simply blocked by the server before they are passed to other participants. The messages may also be used to request that the leader rewind or pause playback if one participant needs to step away from the viewing experience for a time.

The examples of the relative sizes of the various on-screen areas shown in FIGS. 4B and 4C are merely for illustration purpose. These areas may be resized on a per-client basis or may be allocated for maximum viewing enjoyment. In some cases, text messages could be overlaid over full screen content presentations (in the fashion of captions, for example), but this may detract from the viewing experience and so participants may have the option to prevent such text from being presented. In some cases, the content will be shown in full screen unless a viewer affirmatively elects a different view, while in other cases, the default viewing mode may be the discussion view, etc. In the full screen view, audio comments from the other participants (e.g., as gathered by microphones associated with the set-top boxes or remote controls of the participants) may be shared with the other participants (e.g., in lieu of text comments). Or, text comments may be presented at a set-top box as audio comments when a user is in full screen mode, provided that processing means exist, either in the set-top box or on the network, to perform the required text-to-speech conversion (as is contemplated in an embodiment of the invention). Note that it is also possible to use a microphone to compose text messages if the set-top box or remote control or some means on the network is equipped with a speech-to-text converter (as is contemplated in a further embodiment of the invention).

In some cases, the viewing mode may be established for all participants by the leader. This would ensure that all viewers have a common experience. In other cases, however, viewing modes may be individually controlled by each viewer. This would still allow for the shared experience, but on terms more acceptable to an individual user. For example, a user may want to participate in text messaging, but not video conferencing and so the user may disable his/her web cam and not permit a feed there from to be provided to the other participants.

In some embodiments of the invention, rather than presenting text messages in a conventional line-by-line fashion, the text messages could be presented as a one or more lines in a screen ticker or crawler (e.g., in the fashion of a scrolling ticker-tape at or near the bottom (or elsewhere) of the screen). In some cases, as a message is “retired” from the ticker it may be accumulated to a line-by-line display at a side of the content viewing area. This line-by-line display of messages may be scrollable or sortable, so that older messages can be reviewed. The messages are preferably prefaced by an indication of the author thereof, but this need not necessarily be so.

In addition to comments of the other participants, in some embodiments information other than comments may be provided via the on-screen ticker or text fields. For example, information from news feeds, web logs (blogs), or other feeds (e.g., RSS or other feeds) may be provided in the ticker or text fields. This information may concern the content being viewed (e.g., as gathered from various Internet or other sources) or may be unrelated to same (e.g., in the case of current news headlines and the like displayed while watching a movie). The organizer or another participant may establish feeds for the group of participants so that information of importance to the viewer community is displayed (e.g., sports scores, breaking news, the start of other events, etc.). In this way, the ticker or text field acts as an aggregation point for information collected from a variety of sources (including user-generated content). When the information notification/alert relates to video content then the display may be of an icon or picture-in-picture of that content, instead of text.

On some occasions, data ancillary to the shared view experience (e.g., text, audio, and/or video messages) may be recorded and stored by server 106 or elsewhere in the system along with a time-stamp indicating the time of their occurrence relative to, for example, the time of delivery of the content item and/or the run-time of the content item. In this way, the content item or items may be viewed, or reviewed, by an original or new participant at a time other than (generally later than) the originally scheduled time of the playing of the content item or items and the ancillary information may be synchronized with, and played in real-time relative to, the playing of the content item or items. Such an original or new participant, reviewing or viewing at a time other than the originally scheduled playing time, would be able to select amongst all of the allowed viewing options that would have been available to them during the original shared view experience; that is the content item or items plus any associated ancillary data generated during that original shared view experience.

In addition to live or pre-recorded content, the present invention is useful in connection with playlists. Playlists are defined lists of audio/video (or just audio or just video) content items (e.g., television programs (both live and stored), user-generated content, Internet-based content, etc.) selected to run either in sequence or, if a shuffle playlist function is selected, in a random or pseudorandom order. Playlists may comprise content items of a similar genre, from a common channel or content provider, from a common type of channel or content provider, or other user-defined or provider-defined criteria. Some playlists may include content recommendations, ratings, and/or reviews. In accordance with embodiments of the invention, users are able to create playlists, thereby planning viewing schedules in advance of the viewing time. Invitations to participate in playlist viewing may encompass an entire playlist or just portions thereof and different participants may be invited to participate in the viewing experience at different points in the playlist (e.g., a group of one set of friends for the sporting event portion and a group of different friends for the movie portion, etc.)

In the case of playlists, they would be distributed in a manner similar to the process 300 illustrated in FIG. 3. The initiator (group leader) of the process distributes a playlist of various content items to the group of second (participating) clients chosen. The recipients may accept, decline, or propose changes to the playlist in a manner similar to the process 300 illustrated in FIG. 3. The primary difference is that, in the use of a play list, control of the viewing experience remains in the hands of the recipient and is not ceded to another. When the shared viewing experience is a playlist, the participant may not be required adhere to viewing the one or more content items included in the playlist or in the timing of their delivery. In some instances, a playlist may be distributed for informational purposes where a group of participants might share the planning of shared viewing experiences to be included in a playlist that they will all view in a manner similar to, for example, a book group. Although such playlists might be distributed amongst groups of friends or people with common interests, playlists (perhaps of, or generated by, famous personalities) may also be made available to some or all users of a network-based content delivery system on an informational basis, whether freely or for a separate subscription to such playlists. When a participant accepts an invitation including a playlist, the participant may choose to accept the invitation for information purposes only (so that server 106 and/or set-top box 104 of the participant is not configured to play the content items included the playlist) or may choose to incorporate the playlist into the control function of the viewing experience, such that server 106 and/or set-top box 104 may automatically deliver, to the participant's display device, the content specified by the playlist without any need for intervention (i.e. no need to select or change channel etc.). The participant may retain the ability to intervene in the playing of the content items included in the playlist in order to terminate, deviate from, pause, modify, or otherwise the alter the progress of the delivery of the content items automatically under control of the playlist information.

The present invention is also applicable in connection with user-generated content, such as gaming activities. Simultaneous web cam and/or audio feeds may be shared amongst players in a game such as poker, bridge, chess, a board game, etc. Instead of television content, the web cam feed may provide a view of a game board and players could participate with one another without having to be physically present in the same room. In some cases, the game board may be a virtual construct presented by an application running on server 106 (or an affiliated server) and players could interact with one another and the game board (or, more generally, the game environment) through the present system. Likewise, educational seminars or other events could be hosted in the multi-point environment provided by the present invention. In the case of games and the like, spectators could be invited to view the event just as is the case for television or other content.

Thus, methods and systems for sharing a content viewing experience among geographically separated users in a network-based content delivery system have been described.

What is claimed is:

1. A method for sharing a content viewing experience among geographically separated users in a network-based content delivery system, comprising:
distributing, by one or more servers, an invitation to view a common audio-video content item to individual clients of a plurality of geographically separated participants in the content viewing experience, wherein the invitation includes a description of the common audio-video content item, a time the common audio-video content item is available for distribution, and means for accepting the invitation;
upon receipt of an acceptance of the invitation, distributing by the one or more servers, during the time the common audio-video content item is available for viewing, the common audio-video content item to each of said individual clients of participants that accepted the invitation; and
playing, at each of said individual clients of participants that accepted the invitation, the common audio-video content item under the common control of one of the clients.

2. The method of claim 1, further comprising:
receiving, from one of the clients, a request to reschedule distribution of the common audio-video content item.

3. The method of claim 2, further comprising:
upon acceptance of the request to reschedule distribution of the common audio-video content item, distributing by the one or more servers, a new invitation to view the common audio-video content item to the plurality of participants wherein the new invitation includes a description of the common audio-video content item, a new time the common audio-video content item is available for distribution, and means for accepting the invitation.

4. The method of claim 2, further comprising:
transferring, by the server, common control of the common audio-video content item to another of the clients.

5. The method of claim 1, further comprising:
providing, by the server, an opportunity for in-band interaction among participants via each participant's respective client.

6. The method of claim 5, wherein the in-band interaction includes at least one of a posting of a message by one or more of the clients, an exchange of in-system messages between clients, a threaded discussion board, a text message, an audio feed, and a video feed.

7. The method of claim 5, wherein the in-band interaction is played along with the common content item.

8. The method of claim 5, wherein the in-band interaction occurs in real-time relative to the viewing experience.

9. The method of claim 5, further comprising:
time-stamping data received via the in-band interaction with a time of the data's introduction into the in-band interaction relative to at least one of a time of day in which the common audio-video content item is distributed and a run-time of the content item such that playing of the data is synchronized with a playing of the common audio-video content item.

10. The method of claim 1, further comprising:
providing, by the server, a plurality of display options for viewing the common audio-video content item to the clients.

11. The method of claim 10, wherein selection of a display option for viewing the common audio-video content item is controlled by at least one of the client controlling the playing of the common audio-video content item and a client of individual participants that accepted the invitation.

12. The method of claim 1, further comprising:
creating, by the server, a playlist of common audio-video content items.

13. The method of claim 12, further comprising:
distributing, by the server, an invitation to view the playlist to the plurality of geographically separated participants, wherein the invitation includes a description of at least one of the playlist and one or more of the common audio-video content items included in the playlist.

14. The method of claim 1, further comprising:
upon receipt of an acceptance of the invitation, distributing by the one or more servers, a reminder notice to one or more of said individual clients of participants that accepted the invitation providing at least one of a start time for the viewing of the common audio-video content item and an indication that the common audio-video content item is available for viewing.

15. The method of claim 1, further comprising:
providing, by the server, an opportunity to opt out of viewing the common audio-video content item.

16. The method of claim 1, wherein the network-based content delivery system is at least one of a television content distribution network, a hybrid fiber coaxial cable content distribution network, a satellite content distribution network, a local area network (LAN) content distribution network, a wireless LAN (WLAN) content distribution network, and an Internet based content distribution network.

17. The method of claim 1, further comprising:
receiving at the server, from at least one client, contact information for a participant; and
generating at the server a community of participants using the received contact information.

18. The method of claim 17, wherein the contact information is received via uploading a contact list from a source external to the server.

19. The method of claim 1, wherein the invitation is distributed at the request of a first client and the first client is associated with a first client account with the network-based content delivery system, the method further comprising:
updating, by the server, the first client account to indicate at least one of the distribution of the invitation, the acceptance of the invitation by one or more of the participants, receipt of a rescheduling request, an indication of the client in common control of the playing of the common audio-video content item, and a playing of the common audio-video content item by a participant.

20. The method of claim 1, wherein the participants are associated with participant accounts with the network-based content delivery system, the method further comprising:
updating, by the server, the participant accounts to indicate at least one of receipt of the invitation, acceptance of the invitation, and a schedule of common audio-video content items available for playing.

21. The method of claim 1, further comprising:
determining at the server whether a participant has sufficient subscription rights to view the common audio-video content items; and, if not,
providing, by the server, at least one of an opportunity for the participant to purchase subscription rights sufficient to view the common audio-video content item and an opportunity for the creator of the invitation to view the common audio-video content item to purchase for the participant that accepted the invitation sufficient rights to view the common audio-video content item, otherwise facilitating playback of the common audio-video content items on the client of the participant that accepted the invitation.

22. The method of claim 1, wherein the invitation further includes a comment.

23. The method of claim 1, wherein the invitation is sent to a wireless communication device other than an individual client of a participant.

24. The method of claim 23, wherein the acceptance of the invitation is received from the wireless communication device.

25. A system for sharing a content viewing experience among geographically separated participants in a network-based content delivery system, comprising:
a server configured to distribute an invitation to view a common audio-video content item to individual clients of a plurality of geographically separated participants in the content viewing experience, wherein the invitation includes a description of the common audio-video content item, a time the common audio-video content item is available for distribution, and means for accepting the invitation, receive an acceptance of the invitation, and distribute, during the time the common audio-video content item is available for viewing, the common audio-video content item to each of said individual clients of participants that accepted the invitation; and
the individual clients communicatively coupled to the server and configured to receive the invitation from the server, accept the invitation, receive the common audio-video content item from the server, and play the common audio-video content item.

26. The system of claim 25, wherein the server is further configured to determine whether the participant that accepted the invitation has sufficient subscription rights to view the common audio-video content item and, if not, provide, by the server, at least one of an opportunity for the participant that accepted the invitation to purchase subscription rights sufficient to view the common audio-video content item and an opportunity for the creator of the invitation to view the common audio-video content item to purchase for the participant that accepted the invitation sufficient rights to view the common audio-video content item, otherwise facilitate playback of the common audio-video content items on the client of the participant that accepted the invitation.

27. An apparatus for sharing a content viewing experience among geographically separated participants in a network-based content delivery system, said apparatus comprising means for distributing an invitation to view a common audio-video content item to individual clients of a plurality of geographically separated participants in the content viewing experience, wherein the invitation includes a description of the common audio-video content item, a time the common audio-video content item is available for distribution, and means for accepting the invitation; and
upon receipt of an acceptance of the invitation, distributing, during the time the common audio-video content item is available for viewing, the common audio-video content item to each of said individual clients of participants that accepted the invitation.

28. The apparatus of claim 27, wherein said apparatus further comprises means for determining at the server whether the participant that accepted the invitation has sufficient subscription rights to view the common audio-video content item; and, if not,
providing, by the server, at least one of an opportunity for the participant that accepted the invitation to purchase subscription rights sufficient to view the common audio-video content item and an opportunity for the creator of the invitation to view the common audio-video content item to purchase for the participant that accepted the invitation sufficient rights to view the common audio-video content item, otherwise facilitating playback of the common audio-video content items on the client of the participant that accepted the invitation.
